(19) United States
(12) Patent Application Publication
(10) Pub. No.: US 2025/0246673 A1
(43) Pub. Date: Jul. 31, 2025

(54) LIQUID ADDITIVE WITH HIGH LITHIUM ION CONDUCTIVITY AND LOW REACTIVITY WITH SOLID ELECTROLYTE, AND ALL-SOLID-STATE BATTERY CAPABLE OF OPERATING AT ROOM TEMPERATURE AND LOW PRESSURE INCLUDING SAME

(71) Applicants: Hyundai Motor Company, Seoul (KR); Kia Corporation, Seoul (KR); SEOUL NATIONAL UNIVERSITY R&DB FOUNDATION, Seoul (KR)

(72) Inventors: Ji Young Kim, Suwon (KR); Sam Ick Son, Suwon (KR); Ki Yoon Bae, Seoul (KR); Jang Wook Choi, Seoul (KR); Noh Joon Lee, Seoul (KR); Ji Hoon Oh, Seoul (KR); Ye Eun Sohn, Seoul (KR)

(21) Appl. No.: 18/769,043

(22) Filed: Jul. 10, 2024

(30) Foreign Application Priority Data
Jan. 29, 2024 (KR) 10-2024-0012861

(51) Int. Cl. H01M 10/056; H01M 10/0525

(52) U.S. Cl. CPC H01M 10/056; H01M 10/0525; H01M 2300/0065

(57) ABSTRACT

A liquid additive for an all-solid-state battery capable of operating under conditions of room temperature and low pressure, and an all-solid-state battery including the same. Specifically, by adding a liquid additive having low reactivity with a solid electrolyte and high lithium ion conductivity to an anode layer, a cathode layer, or a solid electrolyte layer, ionic conductivity and current density robustness of the all-solid-state battery can be improved under conditions of room temperature and low pressure.

### CROSS-REFERENCE TO RELATED APPLICATION

This application claims, under 35 U.S.C. § 119 (a), the benefit of Korean Patent Application No. 10-2024-0012861, filed on Jan. 29, 2024, the entire contents of which are incorporated herein by reference.

### BACKGROUND

### Technical Field

The present disclosure relates to a liquid additive for an all-solid-state battery capable of operating under conditions of room temperature and low pressure, and an all-solid-state battery including the same. More particularly, by adding a liquid additive having low reactivity with a solid electrolyte and high lithium ion conductivity to a composite anode layer, a composite cathode layer, or a solid electrolyte layer, ionic conductivity and current density robustness of the all-solid-state battery may be improved under conditions of room temperature and low pressure.

### Background

All-solid-state batteries, which are attracting attention as next-generation secondary batteries, are configured such that all components are made of solids, and thus have advantages of low risk of fire and explosion and high mechanical strength compared to lithium-ion batteries using flammable organic solvents as electrolytes. This all-solid-state battery generally includes a cathode layer attached to a cathode current collector, an anode layer attached to an anode current collector, and a solid electrolyte layer disposed between the cathode layer and the anode layer.

The anode layer is used in the form of a composite anode layer by mixing an anode active material such as graphite, silicon, etc. with a solid electrolyte for lithium ion (Li⁺) conduction. Since the solid electrolyte has higher specific gravity than the liquid electrolyte, the conventional all-solid-state batteries are disadvantageous because energy density is lower than that of lithium-ion batteries and ionic conductivity may be decreased due to voids between the solid electrolyte and the anode active material.

Also, the cathode layer may be used in the form of a composite cathode layer by mixing a cathode active material such as lithium composite oxide with a solid electrolyte. As such, density is also lower than that of a lithium-ion battery and internal resistance increases and ionic conductivity decreases due to voids that exist between the solid electrolyte and the cathode active material, which is undesirable.

For commercialization, an all-solid-state battery must be able to operate under conditions of room temperature and low clamping pressure. However, when lowering the clamping pressure of an all-solid-state battery, it is difficult to recover voids generated by the volume change of the solid electrolyte layer or electrodes including the solid electrolyte. The internal voids created in the layers including the solid electrolyte (e.g., a solid electrolyte layer, a composite anode layer, a composite cathode layer) may block the lithium ion conduction path, causing deterioration in cell performance, including current density robustness.

Meanwhile, a storage-type anodeless all-solid-state battery, which eliminates the anode layer of an all-solid-state battery or uses only a small amount of anode active material and precipitates lithium ions (Li⁺) directly as lithium metal or a lithium alloy on the anode current collector, is proposed.

Anodeless all-solid-state batteries do not use anode active materials that may store lithium ions. During charging, lithium ions (Li⁺) released by the cathode layer are converted into lithium metal by reduction with electrons on the surface of the anode current collector through the solid electrolyte layer. During discharging, the opposite electrochemical reaction occurs. Briefly, an anodeless all-solid-state battery may be charged and discharged even without an anode active material.

In such anodeless all-solid-state batteries, voids are created between the solid electrolyte layer and the anode current collector due to the irregular surface of the solid electrolyte layer and hardness of the anode current collector, making it difficult for lithium metal to be uniformly precipitated. These problems may become worse when an anodeless all-solid-state battery operates under conditions of room temperature and low clamping pressure in order to commercialize an all-solid-state battery.

### SUMMARY OF THE DISCLOSURE

As mentioned above, in order to allow an all-solid-state battery, especially an anodeless all-solid-state battery to operate under conditions of room temperature and low clamping pressure, voids between the active material and the solid electrolyte or voids between solid electrolytes have to be filled with a compound having high lithium ion conductivity.

The present disclosure has been made keeping in mind such problems and is intended to provide a liquid additive capable of maintaining ionic conductivity even when voids are created in the layer including a solid electrolyte under conditions of room temperature and low clamping pressure, by filling the layer including the solid electrolyte among multiple layers constituting the all-solid-state battery with a material having high lithium ion conductivity.

The objects of the present disclosure are not limited to the foregoing. The objects of the present disclosure will be able to be clearly understood through the following description and to be realized by the means described in the claims and combinations thereof.

An embodiment of the present disclosure provides a liquid additive for a solid electrolyte, including a lithium salt and a solvent having ability to dissolve the lithium salt and compatibility with a solid electrolyte, in which the solvent includes an orthoester compound.

In one aspect, the solvent orthoester component may have the formula (RC(OR′)₃) where R is H or optionally substituted C1-12 alkyl and is preferably H or optionally substituted C1-6 alkyl and is still more preferably H; and each R′ is the same or different optionally substituted C1-12 alkyl and is preferably optionally substituted C1-6 alkyl such as methyl, ethyl, propyl, butyl, pentyl or hexyl (including branched groups such as isopropyl, sec-butyl and the like). In certain embodiments, to the group R and R′ of the formula (RC(OR′)₃) may be unsubstituted.

For example, the solvent may include any one selected from the group consisting of trimethyl orthoformate (TMOF), triethyl orthoformate (TEOF), tripropyl orthoformate (TPOF), tributyl orthoformate (TBOF), diethyl phenyl orthoformate (DPOF), and combinations thereof.

Preferably, the solvent includes trimethyl orthoformate (TMOF).

In an embodiment, a dipole moment of the solvent may be less than 2.00 D (e.g., trimethyl orthoformate: 1.70 D; triethyl orthoformate: 1.67 D; tripropyl orthoformate: 1.64 D, tributyl orthoformate: 1.66 D).

In an embodiment, the lithium salt may include any one selected from the group consisting of LiCl, LiBr, LiI, LiBF₄, LiClO₄, LiB₁₀Cl₁₀, LiAlCl₄, LiAlO₄, LiPF₆, LiCF₃SO₃, LiCH₃CO₂, LiCF₃CO₂, LiAsF₆, LiSbF₆, LiCH₃SO₃, LiN(SO₂F)₂ (Lithium bis(fluorosulfonyl)imide, LiFSI), LiN(SO₂CF₂CF₃)₂ (lithium bis(pentafluoroethanesulfonyl)imide, LiBETI), LiN(SO₂CF₃)₂ (lithium bis(trifluoromethane sulfonyl)imide, LiTFSI), and combinations thereof.

In an embodiment, the concentration of the lithium salt may be 0.1 M to 10 M.

Another embodiment of the present disclosure provides a solid electrolyte layer, including a solid electrolyte and the liquid additive described above.

Here, the solid electrolyte may include a sulfide-based solid electrolyte.

Also, the solid electrolyte layer may include 0.1 wt % to 20 wt % of the liquid additive.

Still another embodiment of the present disclosure provides a composite cathode layer, including a cathode active material, a solid electrolyte, and the liquid additive described above.

Here, the solid electrolyte may include a sulfide-based or sulfide-containing solid electrolyte.

Yet another embodiment of the present disclosure provides a composite anode layer, including an anode active material, a solid electrolyte, and the liquid additive described above.

Here, the solid electrolyte may include a sulfide-based or sulfide-containing solid electrolyte.

Still yet another embodiment of the present disclosure provides an all-solid-state battery, including an anode including an anode current collector and an anode layer, a cathode including a cathode current collector and a cathode layer, and the solid electrolyte layer disposed between the anode and the cathode.

In an embodiment, the all-solid-state battery may further include a restraining portion disposed outside the anode, the solid electrolyte layer, and the cathode and configured to press the anode, the solid electrolyte layer, and the cathode in a stacking direction, in which the clamping pressure applied by the restraining portion to the anode, the solid electrolyte layer, and the cathode is 0.1 MPa to 10 MPa.

In an embodiment, the all-solid-state battery may be configured to operate under conditions of room temperature.

In a further aspect, vehicles are provided that comprise an all-solid-state battery as disclosed herein.

### BRIEF DESCRIPTION OF THE DRAWINGS

The above and other features of the present disclosure will now be described in detail referring to certain exemplary embodiments thereof illustrated in the accompanying drawings, which are given hereinbelow by way of illustration only, and thus are not limitative of the present disclosure, and wherein:

FIG. 1 shows an all-solid-state battery including a liquid additive according to the present disclosure;

FIG. 2 shows results of symmetric cell testing on batteries including Example 1-1 and Example 2;

FIG. 3 shows results of evaluating electrochemical properties of half coin cells including Example 1-1, Example 2, and Comparative Example 1;

FIG. 4 shows results of impedance measurement for the solid electrolyte including Example 1-1;

FIG. 5 shows results of impedance measurement for the solid electrolyte including Example 2;

FIG. 6 shows results of impedance measurement for the solid electrolyte including Example 3;

FIG. 7 shows results of impedance measurement for the solid electrolyte including Example 4;

FIG. 8 shows results of impedance measurement for the solid electrolyte including Example 5;

FIG. 9 shows results of impedance measurement for a sulfide-based or sulfide-containing solid electrolyte and a solid electrolyte including the sulfide-containing solid electrolyte and Example 1 mixed at a predetermined weight ratio;

FIG. 10 shows results of impedance measurement for a sulfide-containing solid electrolyte and a solid electrolyte including the sulfide-containing solid electrolyte and Comparative Example 1 mixed at a predetermined weight ratio;

FIG. 11 shows results of symmetric cell testing on a battery including Example 1-2; and

FIG. 12 shows results of symmetric cell testing on a battery including no liquid additive.

### DETAILED DESCRIPTION

The above and other objects, features and advantages of the present disclosure will be more clearly understood from the following preferred embodiments taken in conjunction with the accompanying drawings. However, the present disclosure is not limited to the embodiments disclosed herein, and may be modified into different forms. These embodiments are provided to thoroughly explain the disclosure and to sufficiently transfer the spirit of the present disclosure to those skilled in the art.

Throughout the drawings, the same reference numerals will refer to the same or like elements. For the sake of clarity of the present disclosure, the dimensions of structures are depicted as being larger than the actual sizes thereof. It will be understood that, although terms such as “first”, “second”, etc. may be used herein to describe various elements, these elements are not to be limited by these terms. These terms are only used to distinguish one element from another element. For instance, a “first” element discussed below could be termed a “second” element without departing from the scope of the present disclosure. Similarly, the “second” element could also be termed a “first” element. As used herein, the singular forms are intended to include the plural forms as well, unless the context clearly indicates otherwise.

It will be further understood that the terms “comprise”, “include”, “have”, etc., when used in this specification, specify the presence of stated features, integers, steps, operations, elements, components, or combinations thereof, but do not preclude the presence or addition of one or more other features, integers, steps, operations, elements, components, or combinations thereof. Also, it will be understood that when an element such as a layer, film, area, or sheet is referred to as being “on” another element, it may be directly on the other element, or intervening elements may be present therebetween. Similarly, when an element such as a layer, film, area, or sheet is referred to as being “under” another element, it may be directly under the other element, or intervening elements may be present therebetween.

A term “sheet-type” or its derivatives as used herein refers to a three-dimensional shape of a sheet, film or a thin layer, which has a planar surface and a substantially reduced thickness (e.g., millimeter, micrometer, or nanometer scale) compared to a width or a length of the planar surface.

A term “cylindrical shape” or its derivatives as used herein refers to a three-dimensional shape having a hollow, empty inner space of an object, and the cylindrical shape can be defined with a cross sectional shape with an inner diameter and an outer diameter and a length of an object, where the inner diameter is a diameter of the hollow space in the object and the outer diameter is a diameter of the outer barrier of the cross section of the object.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

As referred to herein, the term “optionally substituted” with respect to the group R and R′ of the formula (RC(OR′)₃) indicate the specified group such as an alkyl group b may be substituted at one or more available positions by suitable groups such as halogen (F, Br, C, or I), amino, amino alkyl, alkyl sulfide, ketoalkyl, hydroxyalkyl (e.g. —CH2-CH(OH)C1-4 alkyl), phenyl or other carbocyclic aryl, and the like.

Unless otherwise specified, all numbers, values, and/or representations that express the amounts of components, reaction conditions, polymer compositions, and mixtures used herein are to be taken as approximations including various uncertainties affecting measurement that inherently occur in obtaining these values, among others, and thus should be understood to be modified by the term “about” in all cases. Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”. Furthermore, when a numerical range is disclosed in this specification, the range is continuous, and includes all values from the minimum value of said range to the maximum value thereof, unless otherwise indicated. Moreover, when such a range pertains to integer values, all integers including the minimum value to the maximum value are included, unless otherwise indicated.

In the present specification, when a range is described for a variable, it will be understood that the variable includes all values including the end points described within the stated range. For example, the range of “5 to 10” will be understood to include any subranges, such as 6 to 10, 7 to 10, 6 to 9, 7 to 9, and the like, as well as individual values of 5, 6, 7, 8, 9 and 10, and will also be understood to include any value between valid integers within the stated range, such as 5.5, 6.5, 7.5, 5.5 to 8.5, 6.5 to 9, and the like. Also, for example, the range of “10% to 30%” will be understood to include subranges, such as 10% to 15%, 12% to 18%, 20% to 30%, etc., as well as all integers including values of 10%, 11%, 12%, 13% and the like up to 30%, and will also be understood to include any value between valid integers within the stated range, such as 10.5%, 15.5%, 25.5%, and the like.

### Liquid Additive

In general, all-solid-state batteries require high clamping pressure of hundreds of MPa to operate efficiently due to the fact that all components are solids. In order to apply an all-solid-state battery to electric vehicles and other applications, the all-solid-state battery must be able to operate under conditions of room temperature and low clamping pressure. However, under these conditions, there are limits to operating at a certain level of current density or more. In addition, under low clamping pressure, it may be difficult to recover voids created within the electrodes due to volume changes in the electrodes due to charging and discharging.

Voids created inside the electrodes or inside the solid electrolyte layer may block the lithium ion conduction path, causing deterioration in cell performance, including current density robustness. The present disclosure is intended to solve the problems described above.

The liquid additive for a solid electrolyte according to the present disclosure may include a lithium salt and a solvent having the ability to dissolve the lithium salt and compatibility with the solid electrolyte.

The lithium salt may be used without particular limitation, so long as it is commonly used in lithium-ion batteries using a liquid electrolyte. For example, the lithium salt may include any one selected from the group consisting of LiCl, LiBr, LiI, LiBF₄, LiClO₄, LiB₁₀Cl₁₀, LiAlCl₄, LiAlO₄, LiPF₆, LiCF₃SO₃, LiCH₃CO₂, LiCF₃CO₂, LiAsF₆, LiSbF₆, LiCH₃SO₃, LiN(SO₂F)₂ (lithium bis(fluorosulfonyl)imide, LiFSI), LiN(SO₂CF₂CF₃)₂ (lithium bis(pentafluoroethanesulfonyl)imide, LiBETI), LiN(SO₂CF₃)₂ (lithium bis(trifluoromethane sulfonyl)imide, LiTFSI), and combinations thereof.

In an embodiment, the concentration of the lithium salt added to the solvent may be 0.1 M to 10 M. When the concentration of the lithium salt falls within the above numerical range, appropriate lithium ion conductivity may be provided. If the concentration of the lithium salt is less than 0.1 M, an excess amount of liquid additive may need to be added to provide sufficient lithium ion conductivity to each layer of the all-solid-state battery. On the other hand, if the concentration of the lithium salt exceeds 10 M, the uniform addition thereof to the layer including the solid electrolyte may be difficult due to high viscosity of the liquid additive.

The liquid additive may include the lithium salt and may thus have high lithium ion conductivity. The liquid additive, which is in a liquid phase, may be loaded in the voids that cause a decrease in lithium ion conduction within an anode layer 20, a cathode layer 40, or a solid electrolyte layer 30, including a solid electrolyte. In this way, by removing the causes of decreased lithium ion conductivity, such as voids, a material having high lithium ion conductivity may replace the same and function like a liquid electrolyte within each layer.

In an embodiment, the solvent may include, for example, an orthoester such as a material having the formula (RC(OR′)₃) (where R and R′ are defined above), and suitably having the ability to dissolve or solvate the lithium salt. The orthoester is an organic material with three alkoxy groups (OR′) attached to one carbon atom, and the type of R or R′may be applied without particular limitation so long as it has the ability to dissolve the lithium salt. Preferred R and R′ groups of (RC(OR′)₃) are where R is H or optionally substituted C1-12 alkyl and is preferably H or optionally substituted C1-6 alkyl and is still more preferably H; and each R′ is the same or different optionally substituted C1-12 alkyl and is preferably optionally substituted C1-6 alkyl such as methyl, ethyl, propyl, butyl, pentyl or hexyl (including branched groups such as isopropyl, sec-butyl and the like). In certain embodiments, to the group R and R′ of the formula (RC(OR′)₃) may be unsubstituted

Preferably, as discussed above, the solvent includes an orthoformate compound. In preferred aspects, the orthoformate-based compound is configured such that hydrogen (H) is applied to the R group of the orthoester compound. For example, the solvent preferably may include any one selected from the group consisting of trimethyl orthoformate (TMOF), triethyl orthoformate (TEOF), tripropyl orthoformate (TPOF), tributyl orthoformate (TBOF), diethyl phenyl orthoformate (DPOF), and combinations thereof.

More preferably, the solvent includes trimethyl orthoformate (TMOF). Here, triisopropyl orthoformate (TIPOF) is an orthoformate-based compound but does not have the ability to dissolve a lithium salt, making it difficult to serve as a solvent according to the present disclosure.

Also, a solvent having compatibility with the solid electrolyte may be used. Here, “compatibility” may mean that reactivity with the solid electrolyte is low. In particular, the solvent may be compatible with a sulfide-based solid electrolyte.

Sulfide-containing solid electrolytes are being studied worldwide due to high lithium ion conductivity and electrochemical stability thereof. Sulfide-containing solid electrolytes are classified into crystalline and non-crystalline electrolytes depending on the presence or absence of a crystal structure. Representatively, crystalline electrolytes may have thio-LISICON, LGPS, and argyrodite-type crystal structures, and non-crystalline electrolytes may have glass or glass-ceramic structures depending on a difference in the heat treatment temperature.

The sulfide-containing solid electrolyte may react with a solvent having high polarity, destroying it crystallinity and causing a decrease in lithium ion conductivity. To prevent this, the solvent for the liquid additive may be a non-polar or low polarity solvent having low reactivity with the sulfide-based solid electrolyte.

For example, the dipole moment of the solvent may be less than 2.00 D. The dipole moment is determined by measuring the polarity of a molecule or a chemical bond, and the closer the value thereof is to 0, the more likely the solvent is to be non-polar or have low polarity. The liquid additive according to the present disclosure includes a solvent having a dipole moment of less than 2.00 D, and thus has low reactivity with a solid electrolyte, preferably with a sulfide-based solid electrolyte, more preferably with a crystalline sulfide-based solid electrolyte.

If the dipole moment of the solvent is 2.00 D or more, interfacial resistance may increase and lithium ion conductivity may decrease due to an increase in side reactions with the sulfide-based solid electrolyte.

Among specific examples of the solvent, the dipole moment of trimethyl orthoformate (TMOF) is 1.70 D, the dipole moment of triethyl orthoformate (TEOF) is 1.67 D, the dipole moment of tripropyl orthoformate (TPOF)) is 1.64 D, the dipole moment of tributyl orthoformate is 1.66 D, and the dipole moment of diethyl phenyl orthoformate (DPOF) is 2.00D or less.

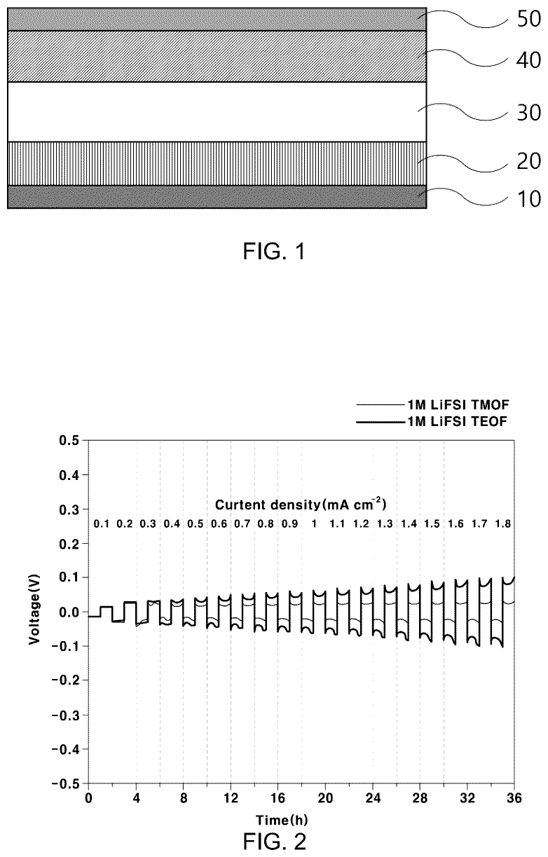

FIG. 1 shows an all-solid-state battery in which the liquid additive according to the present disclosure is included in at least one layer selected from among an anode layer 20, a solid electrolyte layer 30, and a cathode layer 40. Referring to FIG. 1, the all-solid-state battery includes an anode current collector 10, an anode layer 20 disposed on the anode current collector 10, a solid electrolyte layer 30 disposed on the anode layer 20 and configured to include a solid electrolyte, a cathode layer 40 disposed on the solid electrolyte layer 30 and configured to include a cathode active material, and a cathode current collector 50 disposed on the cathode layer 40.

Below is a schematic description of the configuration thereof.

The anode current collector 10 may be a plate-type substrate having electrical conductivity. Specifically, the anode current collector 10 may be in the form of a sheet, a thin film, or a foil.

The anode current collector 10 may include a material that does not react with lithium. Specifically, the anode current collector 10 may include at least one selected from the group consisting of nickel (Ni), copper (Cu), stainless steel, and combinations thereof.

The thickness of the anode current collector 10 is not particularly limited and may be, for example, 1 μm to 500 μm.

The anode layer 20 may include an anode active material and may further include a binder and a solid electrolyte as necessary. The anode active material may be a compound capable of reversibly storing and releasing lithium. For example, the anode active material may include any one selected from the group consisting of a graphite-based active material, a silicon-based active material, lithium titanium oxide, or combinations thereof.

Also, the anode layer 20 may be an anodeless anode layer 20 that does not include a separate anode active material or includes only a very small amount of anode active material.

The anode layer 20 including a solid electrolyte to improve lithium ion conductivity may be referred to as a “composite anode layer.”

According to an embodiment, a composite anode layer including an anode active material, a solid electrolyte, and the liquid additive may be provided. As the composite anode layer includes the liquid additive, lithium ion conductivity may be improved by filling voids therein, and operation of the all-solid-state battery may be improved under conditions of room temperature and low clamping pressure. Preferably, the solid electrolyte includes a sulfide-based solid electrolyte.

The solid electrolyte layer 30 may be disposed between the anode layer 20 and the cathode layer 40 and may include a solid electrolyte having lithium ion conductivity.

The solid electrolyte may include at least one selected from the group consisting of an oxide-based solid electrolyte, a sulfide-based solid electrolyte, a polymer electrolyte, and combinations thereof. Preferably, a sulfide-based solid electrolyte having high lithium ion conductivity is used.

The sulfide-based solid electrolyte is not particularly limited, but examples thereof may include Li₂S—P₂S₅, Li₂S—P₂S₅—LiI, Li₂S—P₂S₅—LiCl, Li₂S—P₂S₅—LiBr, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (in which m and n are positive numbers, and Z is any one selected from among Ge, Zn, and Ga), Li₂S—GeS₂, Li₂S—SiS₂—Li₃PO₄, Li₂S—SiS₂-LiₓMO_{y} (in which x and y are positive numbers, and M is any one selected from among P, Si, Ge, B, Al, Ga, and In), Li₁₀GeP₂S₁₂, and the like.

The sulfide-based solid electrolyte may have an argyrodite-type crystal structure. The argyrodite-type crystal structure is a solid electrolyte that exhibits lithium ion conductivity while having the same crystal structure as argyrodite ore with a composition of Ag₈GeS₆. Li₇PS₆ and Li₆PS₅X (X=Cl, Br, I) are known as Li-argyrodite electrolytes having lithium ion (Li⁺) conductivity in all-solid-state batteries.

Examples of the oxide-based solid electrolyte may include perovskite-type LLTO (Li₃ₓLa_{2/3-x}TiO₃), phosphate-based NASICON-type LATP (Li₁₊ₓAlₓTi₂₋ₓ(PO₄)₃), and the like.

Examples of the polymer electrolyte may include a gel polymer electrolyte, a solid polymer electrolyte, and the like.

The solid electrolyte layer 30 may further include a binder. Examples of the binder may include butadiene rubber, nitrile butadiene rubber, hydrogenated nitrile butadiene rubber, polyvinylidene fluoride (PVDF), polytetrafluoroethylene (PTFE), carboxymethyl cellulose (CMC), and the like.

The solid electrolyte layer 30 may include the liquid additive according to the present disclosure to improve lithium ion conductivity by filling voids between solid electrolyte particles. This allows the all-solid-state battery to operate efficiently under conditions of room temperature and low clamping pressure.

As such, the solid electrolyte layer 30 may include 0.1 wt % to 20 wt % of the liquid additive. If the amount of the liquid additive present in the solid electrolyte layer 30 is less than 0.1 wt %, it is too small to improve lithium ion conductivity and battery operability under common-use conditions. On the other hand, if the amount of the liquid additive exceeds 20 wt %, lithium ion conductivity or battery operability may be improved, but liquid content in the solid electrolyte layer 30 may become too large, resulting in a slurry-like form. Hence, processing into pellet form may become difficult.

Also, the cathode active material layer 40 is configured to reversibly store and release lithium ions, and may include a cathode active material, a conductive material, and a binder. Additionally, some of the solid electrolyte may be mixed.

The cathode active material may be an oxide active material or a sulfide active material.

Examples of the oxide active material may include a rocksalt-layer-type active material such as LiCoO₂, LiMnO₂, LiNiO₂, LiVO₂, Li₁₊ₓNi_{1/3}Co_{1/3}Mn_{1/3}O₂, etc., a spinel-type active material such as LiMn₂O₄, Li(Ni_{0.5}Mn_{1.5})O₄, etc., an inverse-spinel-type active material such as LiNiVO₄, LiCoVO₄, etc., an olivine-type active material such as LiFePO₄, LiMnPO₄, LiCoPO₄, LiNiPO₄, etc., a silicon-including active material such as Li₂FeSiO₄, Li₂MnSiO₄, etc., a rocksalt-layer-type active material in which a portion of a transition metal is substituted with a different metal, such as LiNi_{0.8}Co_{(0.2-x)}AlₓO₂ (0<x<0.2), a spinel-type active material in which a portion of a transition metal is substituted with a different metal, such as Li₁₊ₓMn_{2-x-y}M_{y}O₄ (in which M is at least one selected from among Al, Mg, Co, Fe, Ni, and Zn, 0<x+y<2), lithium titanate such as Li₄Ti₅O₁₂, and the like.

Examples of the sulfide active material may include copper Chevrel, iron sulfide, cobalt sulfide, nickel sulfide, and the like.

Examples of the conductive material may include carbon black, conductive graphite, ethylene black, carbon fiber, graphene, and the like.

Examples of the binder may include butadiene rubber, nitrile butadiene rubber, hydrogenated nitrile butadiene rubber, polyvinylidene fluoride (PVDF), polytetrafluoroethylene (PTFE), carboxymethyl cellulose (CMC), and the like.

The cathode layer 40 further including a solid electrolyte to improve lithium ion conductivity may be referred to as a “composite cathode layer.”

According to another embodiment of the present disclosure, a composite cathode layer including a cathode active material, a solid electrolyte, and the liquid additive may be provided. As the composite cathode layer includes the liquid additive, lithium ion conductivity may be improved by filling voids within the layer, thereby enhancing the operability of the all-solid-state battery under conditions of room temperature and low clamping pressure. Preferably, the solid electrolyte includes a sulfide-based solid electrolyte.

The solid electrolytes included in the composite anode layer, the composite cathode layer, and the solid electrolyte layer 30 may be the same or different from each other. Here, the fact that the solid electrolytes used are the same means that the types of solid electrolytes that may be included are the same, and does not necessarily mean that the same solid electrolyte must be included.

Meanwhile, in all-solid-state batteries, all components are solids, which differs from using a liquid electrolyte. This can lead to an uneven interface bonding state between the solid electrolyte layer 30 and the cathode layer 40 or between the solid electrolyte layer 30 and the anode layer 20. As a result, interfacial resistance may be high. In order to solve this problem, a typical all-solid-state battery may press the anode, the solid electrolyte layer 30, and the cathode by strong clamping pressure of tens to hundreds of MPa.

In an embodiment, the all-solid-state battery may further include a restraining portion disposed outside the anode, the solid electrolyte layer 30, and the cathode and configured to press the anode, the solid electrolyte layer 30, and the cathode in a stacking direction. The clamping pressure applied by the restraining portion to the anode, the solid electrolyte layer 30, and the cathode may be 0.1 MPa to 10 MPa.

If the clamping pressure is less than 0.1 MPa, voids in the anode layer 20, the solid electrolyte layer 30, and the cathode layer 40 may excessively expand during charging of the all-solid-state battery. This can increase interfacial resistance and cause internal short circuit in the battery. On the other hand, if the clamping pressure exceeds 10 MPa, it may be difficult to commercialize the all-solid-state battery according to the present disclosure.

The restraining portion may be applied without particular limitation, so long as it is commonly used to provide clamping pressure to the all-solid-state battery. For example, the restraining portion may have a plate shape.

In an embodiment, the anode includes an anode current collector 10 and an anode layer 20, and the anode layer 20 may be a composite anode layer configured to include an anode active material, a solid electrolyte, and the liquid additive. Furthermore, the anode layer 20 may be provided in a form for constructing an anodeless all-solid-state battery that does not include an anode active material. The cathode includes a cathode current collector 50 and a cathode layer 40, and the cathode layer 40 may be a composite cathode layer 40 configured to include a cathode active material, a solid electrolyte, and the liquid additive. Also, the solid electrolyte layer 30 may be configured to include a solid electrolyte and the liquid additive.

In the all-solid-state battery according to the present disclosure, at least one selected from among the anode, the solid electrolyte layer 30, and the cathode may include the liquid additive, so that the all-solid-state battery may operate under clamping pressure lower than clamping pressure of hundreds of MPa for conventional all-solid-state batteries.

In an embodiment, an all-solid-state battery including the liquid additive may be configured to operate under conditions of room temperature. As such, conditions of room temperature do not necessarily mean about 25° C., but may indicate a temperature at which products to which all-solid-state batteries are applied are typically used or distributed. For example, when the all-solid-state battery is applied to an electric vehicle, conditions of room temperature may be −10° C. to 50° C.

A better understanding of the present disclosure may be obtained through the following examples and comparative examples. However, these examples are not to be construed as limiting the technical spirit of the present disclosure.

### Example 1-1 (1 M LiFSI TMOF)

About 60 μl of LiFSI as a lithium salt was added to a concentration of 1 M to trimethyl orthoformate (TMOF) as a solvent. Then, the mixture was stirred for a sufficient period of time to yield a liquid additive in which the lithium salt was dissolved in the solvent.

### Example 1-2 (2 M LiFSI TMOF)

A liquid additive was prepared through the same process as in Example 1-1, with the exception that LiFSI as the lithium salt was added to a concentration of 2 M.

### Example 2 (1 M LiFSI TEOF)

A liquid additive was prepared through the same process as in Example 1-1, with the exception that triethyl orthoformate (TEOF) was used as a solvent.

### Example 3 (1 M LiFSI TPOF)

A liquid additive was prepared through the same process as in Example 1-1, with the exception that tripropyl orthoformate (TPOF) was used as a solvent.

### Example 4 (1 M LiFSI DPOF)

A liquid additive was prepared through the same process as in Example 1-1, with the exception that diethyl phenyl orthoformate (DPOF) was used as a solvent.

### Example 5 (1 M LiFSI TBOF)

A liquid additive was prepared through the same process as in Example 1-1, with the exception that tributyl orthoformate (TBOF) was used as a solvent.

### Comparative Example 1 (1 M LiFSI DME)

A liquid additive was prepared through the same process as in Example 1, with the exception that dimethyl ether (DME), which was conventionally used in lithium-ion batteries, was used as a solvent.

### Test Example 1—Confirmation of Operability of Liquid Additive

Symmetric cell and half coin cell testing was carried out to confirm whether the liquid additive according to the present disclosure is able to perform the role of lithium ion conduction as a liquid electrolyte.

In the symmetric cell, lithium metal was used for both electrodes and the liquid additive according to Example 1-1 or Example 2 was used as an electrolyte. In the half coin cell, aluminum foil was used as a cathode current collector, an NCM811-based active material was used as a cathode active material, and lithium metal was used as a counter electrode, and the liquid additive according to Example 1-1, Example 2, or Comparative Example 1 was used as an electrolyte.

Referring to FIG. 2, which shows results of symmetric cell testing, both the TMOF solvent and the TEOF solvent exhibited low overvoltage, and Example 1-1 using the TMOF solvent exhibited lower overvoltage than when using the TEOF solvent.

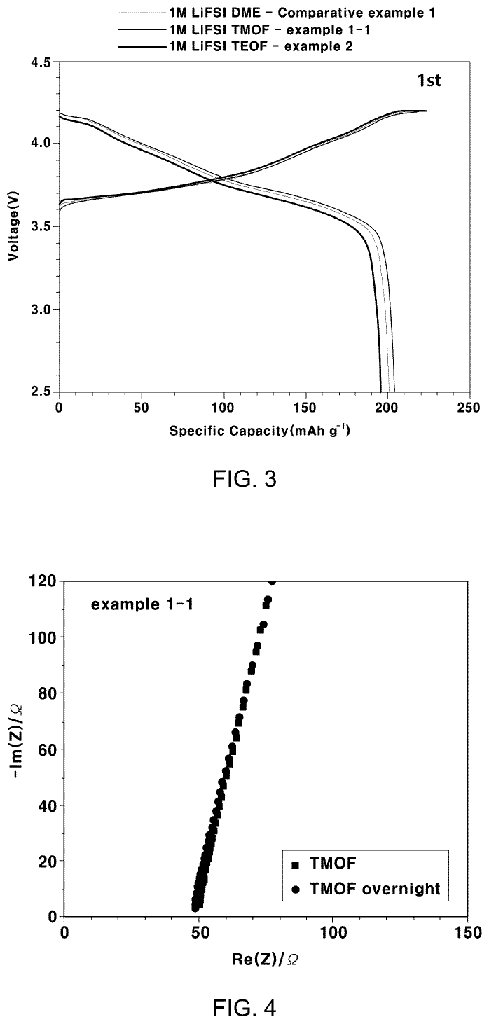

Referring to FIG. 3 regarding the half coin cell testing, both the TMOF solvent and the TEOF solvent exhibited discharge capacity similar to DME, which is a conventional solvent for a liquid electrolyte. Also, Example 1-1 using the TMOF solvent showed higher discharge capacity than Example 2 using the TEOF solvent.

### Test Example 2—Lithium Ion Conductivity of Solid Electrolyte Layer with Liquid Additive Added and Solid Electrolyte Layer with Conventional Liquid Electrolyte Added

(1) A solid electrolyte layer including a sulfide-based solid electrolyte and the liquid additive according to the present disclosure was manufactured to confirm changes in ionic conductivity or side reactivity between the sulfide-based solid electrolyte and the liquid additive. The manufacturing method thereof is specified below.

100 mg of Li₆PS₅Cl as a sulfide-based solid electrolyte and about 10 μl (about 6.67 wt % converted by weight) of the liquid additive according to Example 1-1 were placed in a Thinky mixer (THINKY, ARE-500).

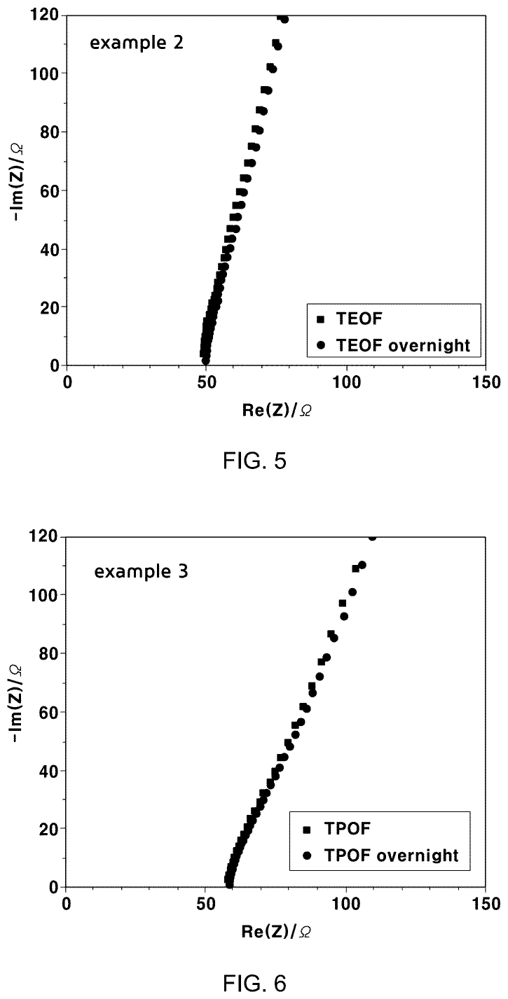

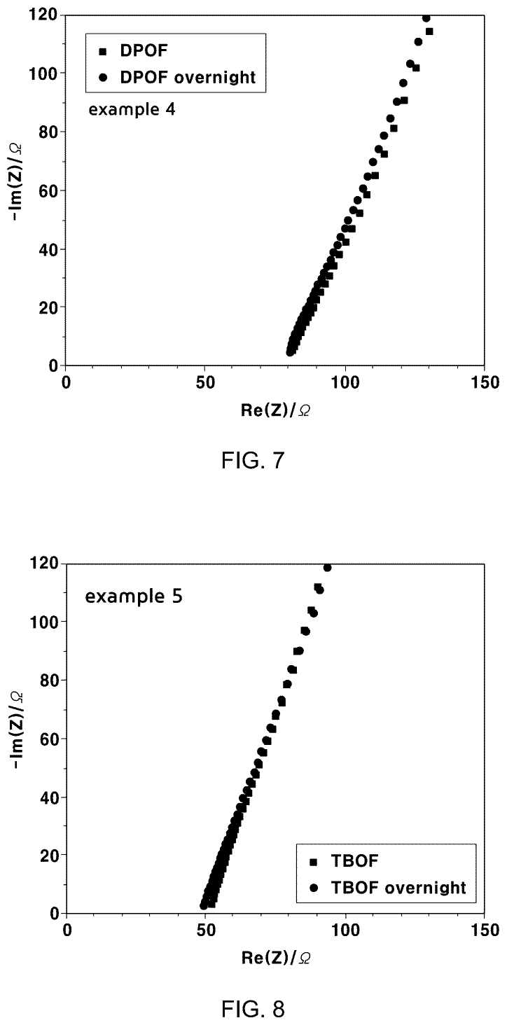

Immediately after the sulfide-based solid electrolyte and the liquid additive were mixed well, the resulting mixture was placed in a pellet mold and pressed to form a cylindrical solid electrolyte layer. Also, after mixing the sulfide-based solid electrolyte and the liquid additive, the mixture was left (overnight) for about 12 hours to allow the solid electrolyte and the liquid additive to react, and then a solid electrolyte layer was manufactured through the same process. The same process was performed for the liquid additives according to Examples 2 to 5, and two solid electrolyte layers were manufactured for each of Examples.
(2) The impedance of a total of 10 solid electrolyte layer samples thus manufactured was measured by a 2-probe method using an impedance analyzer (Solartron 1400A/1455A). The frequency range was 0.1 Hz to 1 MHz, and the amplitude voltage was 10 mV. The results thereof are shown in FIGS. 4 to 8.

Referring to FIGS. 4 to 8, there was almost no difference in resistance between the solid electrolyte layer manufactured immediately after mixing the solid electrolyte and the liquid additive and the solid electrolyte layer manufactured by leaving it for 12 hours after mixing in the same Examples. This is deemed to be due to low reactivity of the liquid additive according to the present disclosure with the sulfide-based solid electrolyte.

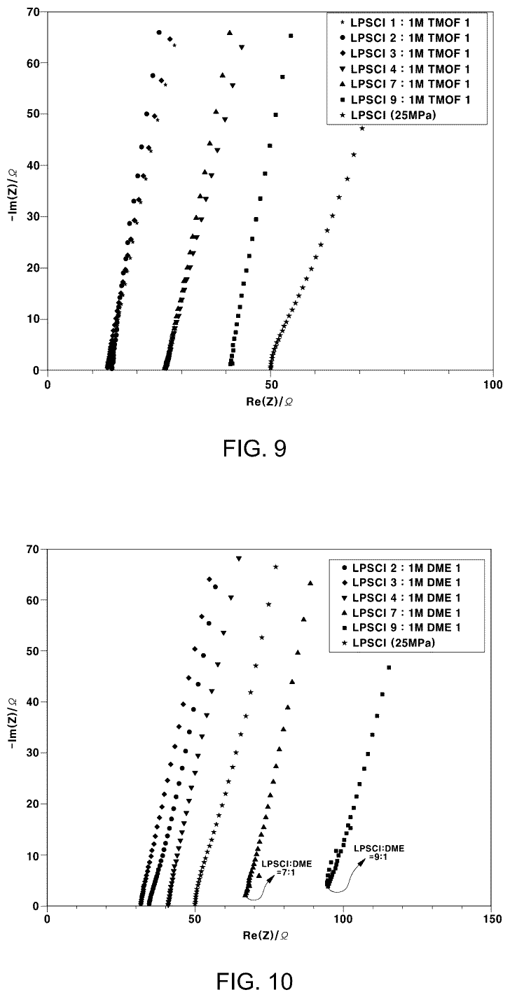

Also, changes in resistance in Example 1-1 using the TMOF solvent were the lowest among Examples. This is deemed to be because TMOF has a lower molecular weight than the other solvents (TEOF, TPOF, DPOF, and TBOF) and thus has lower viscosity, making it easier to fill voids inside the solid electrolyte layer.
(3) A solid electrolyte layer was manufactured by mixing the sulfide-based solid electrolyte and the liquid additive according to Example 1-1 at a weight ratio as shown in Table 1 below. Thereafter, impedance was measured using the impedance analyzer under the same conditions as in FIGS. 4 to 8, and the results thereof are shown in FIG. 9. In addition, as a control, the impedance of a solid electrolyte layer manufactured using Li₆PS₅Cl without adding a liquid additive was measured, and the results thereof are shown in FIG. 9.

Meanwhile, a solid electrolyte layer was manufactured by mixing the sulfide-based solid electrolyte and the liquid additive or liquid electrolyte according to Comparative Example 1 using the DME solvent at a weight ratio as shown in Table 1 below. Then, impedance was measured using an impedance analyzer under the same conditions as in FIGS. 4 to 8, and the results thereof are shown in FIG. 10. In addition, as a control, the impedance of a solid electrolyte layer manufactured using Li₆PS₅Cl without adding a liquid additive was measured, and the results thereof are shown in FIG. 10.

TABLE 1

| LPSCl:1M LiFSI TMOF (weight ratio) | LPSCl:DME (weight ratio) |
|---|---|
| 1:1 | 1:1 |
| 2:1 | 2:1 |
| 3:1 | 3:1 |
| 4:1 | 4:1 |
| 7:1 | 7:1 |
| 9:1 | 9:1 |

(4) Referring to FIG. 9, ionic conductivity of the solid electrolyte layer including the liquid additive according to Example 1-1 was improved (impedance decreased) at all weight ratios compared to when including the solid electrolyte alone. This is deemed to be because the effect of improving lithium ion conductivity due to addition of the liquid additive is greater than the effect of decreasing lithium ion conductivity due to side reaction between the liquid additive and the sulfide-based solid electrolyte.

Referring to FIG. 10, unlike in FIG. 9, when the solid electrolyte and the liquid additive according to Comparative Example 1 were mixed at a ratio of 7:1 or 9:1, ionic conductivity decreased (impedance increased) compared to LPSCl set as a control. This is deemed to be because the effect of decreasing lithium ion conductivity due to side reaction between DME used as the solvent and the sulfide-based solid electrolyte is greater than the effect of increasing lithium ion conductivity due to addition of the liquid additive according to Comparative Example 1.

In addition, when the liquid additive was added in larger amounts (at weight ratios of 4:1, 3:1, and 2:1), the effect of increasing lithium ion conductivity due to the liquid additive was greater than the effect of decreasing lithium ion conductivity due to side reaction with the sulfide-based solid electrolyte.

### Test Example 3—Confirmation of Critical Current Density Through Lithium Symmetric Cell

(1) Li₆PS₅Cl as a sulfide-based solid electrolyte and the liquid additive according to Example 1-2 (2 M LiFSI TMOF) were added to and mixed in a Thinky mixer (THINKY, ARE-500). Immediately after the sulfide-based solid electrolyte and the liquid additive were mixed well, the resulting mixture was placed in a pellet mold and pressed to form a cylindrical solid electrolyte layer. As such, the amount of the liquid additive according to Example 1-2 in the solid electrolyte layer was about 20 wt %.

Then, a symmetric cell (#1) was manufactured using the solid electrolyte layer. As such, lithium metal was used for both electrodes, and a symmetric cell having the same composition was additionally manufactured (#2) to ensure reproducibility of test results. In addition, as a control, a solid electrolyte layer including Li₆PS₅Cl as a sulfide-based solid electrolyte without the liquid additive according to the present disclosure and a symmetric cell using the same were manufactured.

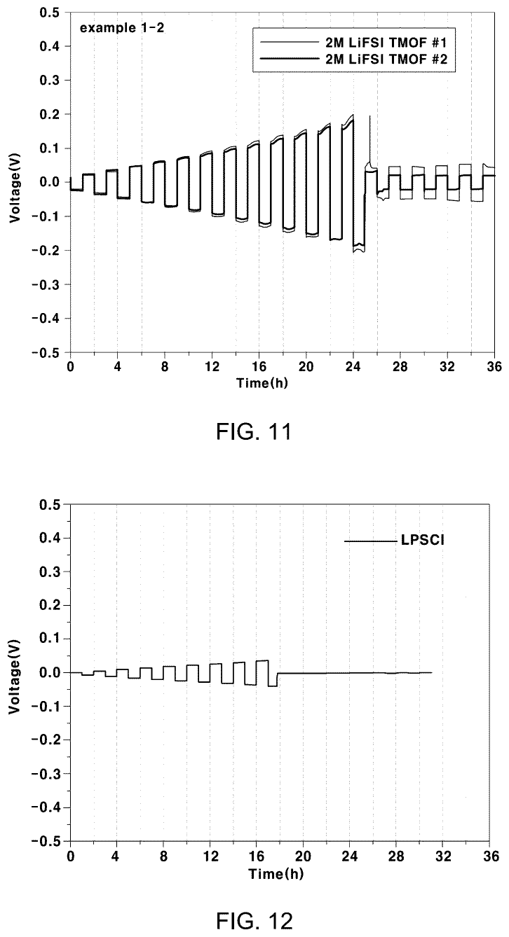

To confirm the effect of improving current density robustness of the battery including the liquid additive according to the present disclosure and the effect of improving operability under conditions of room temperature and low clamping pressure, the symmetric cells #1and #2,along with a control symmetric cell, were tested while increasing current density under conditions of 25° C. and a clamping pressure of 2 MPa. The results thereof are shown in FIGS. 11 and 12. Also, in order to apply the clamping pressure to the symmetric cell, restraining portions were provided to top and bottom of the symmetric cell.

Referring to FIG. 11, the critical current density of the symmetric cell including the liquid additive (Example 1-2) according to the present disclosure was determined to be about 1.2 mA/cm². In contrast, the critical current density of the symmetric cell without the liquid additive was determined to be about 0.9 mA/cm².

Based on such results, the symmetric cell including the liquid additive according to the present disclosure had higher critical current density than the symmetric cell without the liquid additive under conditions of room temperature (25° C.) and low clamping pressure (2 MPa). This is deemed to be because the symmetric cell of the present disclosure enables lithium ion conduction not only by the solid electrolyte but also by the liquid additive. This dual pathway maintains lithium ion conductivity despite the creation of voids during charging and discharging.

According to the present disclosure, a liquid additive includes a lithium salt and an orthoester solvent able to dissolve the same, preferably an orthoformate-based solvent, thereby conferring high ionic conductivity to a solid electrolyte layer, a composite anode layer, or a composite cathode layer, including a solid electrolyte.

In addition, since a solvent with a low dipole moment is used, side reactions with a solid electrolyte, especially with a sulfide-based solid electrolyte, can decrease. This prevents a decrease in lithium ion conductivity due to destruction of crystallinity of the solid electrolyte.

Accordingly, the all-solid-state battery can stably operate under conditions of room temperature and low clamping pressure.

The effects of the present disclosure are not limited to the above-mentioned effects. It should be understood that the effects of the present disclosure include all effects that can be inferred from the description of the present disclosure.

As the embodiments of the present disclosure have been described above, those skilled in the art will appreciate that various modifications and alterations are possible through change, deletion or addition of components without departing from the scope and spirit of the present disclosure as described in the accompanying claims, which will also be said to be included within the scope of the present disclosure.

What is claimed is:

1. A liquid additive for a solid electrolyte, the liquid additive comprising:
a lithium salt; and
a solvent comprising an orthoester compound.

2. The liquid additive of claim 1 wherein the orthoester compound has a structure of (RC(OR′)₃) where R is H or optionally substituted C1-12 alkyl; and each R′ is the same or different optionally substituted C1-12 alkyl.

3. The liquid additive of claim 1 wherein the solvent can solvate the lithium salt and is compatible with a solid electrolyte.

4. The liquid additive of claim 1, wherein the solvent comprises one selected from the group consisting of trimethyl orthoformate (TMOF), triethyl orthoformate (TEOF), tripropyl orthoformate (TPOF), tributyl orthoformate (TBOF), diethyl phenyl orthoformate (DPOF), and combinations thereof.

5. The liquid additive of claim 1, wherein the solvent comprises trimethyl orthoformate (TMOF).

6. The liquid additive of claim 1, wherein a dipole moment of the solvent is less than 2.00 D.

7. The liquid additive of claim 1, wherein the lithium salt comprises one selected from the group consisting of LiCl, LiBr, LiI, LiBF₄, LiClO₄, LiB₁₀Cl₁₀, LiAlCl₄, LiAlO₄, LiPF₆, LiCF₃SO₃, LiCH₃CO₂, LiCF₃CO₂, LiAsF₆, LiSbF₆, LiCH₃SO₃, LiN(SO₂F)₂ (Lithium bis(fluorosulfonyl)imide, LiFSI), LiN(SO₂CF₂CF₃)₂ (lithium bis(pentafluoroethanesulfonyl)imide, LiBETI), LiN(SO₂CF₃)₂ (lithium bis(trifluoromethane sulfonyl)imide, LiTFSI), and combinations thereof.

8. The liquid additive of claim 1, wherein a concentration of the lithium salt is 0.1 M to 10 M.

9. A solid electrolyte layer, comprising:
a solid electrolyte; and
the liquid additive of claim 1.

10. The solid electrolyte layer of claim 9, wherein the solid electrolyte comprises a sulfide-based solid electrolyte.

11. The solid electrolyte layer of claim 9, wherein the solid electrolyte layer comprises 0.1 wt % to 20 wt % of the liquid additive.

12. A composite cathode layer, comprising:
a cathode active material;
a solid electrolyte; and
the liquid additive of claim 1.

13. The composite cathode layer of claim 12, wherein the solid electrolyte comprises a sulfide-based solid electrolyte.

14. The composite cathode layer of claim 13, wherein the solid electrolyte layer comprises 0.1 wt % to 20 wt % of the liquid additive.

15. A composite anode layer, comprising:
an anode active material;
a solid electrolyte; and
the liquid additive of claim 1.

16. The composite anode layer of claim 15, wherein the solid electrolyte comprises a sulfide-based solid electrolyte.

17. An all-solid-state battery, comprising:
an anode comprising an anode current collector and an anode layer;
a cathode comprising a cathode current collector and a cathode layer; and
the solid electrolyte layer of claim 9 disposed between the anode and the cathode.

18. The all-solid-state battery of claim 17, further comprising a restraining portion disposed outside the anode, the solid electrolyte layer, and the cathode and configured to press the anode, the solid electrolyte layer, and the cathode in a stacking direction, wherein clamping pressure applied by the restraining portion to the anode, the solid electrolyte layer, and the cathode is 0.1 MPa to 10 MPa.

19. The all-solid-state battery of claim 17, wherein the all-solid-state battery is configured to operate under conditions of room temperature.

20. A vehicle comprising the all-solid-state battery of claim 17.
